(19) United States
(12) Patent Application Publication
(10) Pub. No.: US 2006/0232826 A1
(43) Pub. Date: Oct. 19, 2006

(54) Method, device, and system of selectively accessing data

(76) Inventor: Hagai Bar-El, Rehovot (IL)

Correspondence Address: PEARL COHEN ZEDEK, LLP, 1500 BROADWAY 12TH FLOOR, NEW YORK, NY, 10036, US

(21) Appl. No.: 11/401,465

(22) Filed: Apr. 11, 2006

Related U.S. Application Data
(60) Provisional application No. 60/670,658, filed on Apr. 13, 2005.

(51) Int. Cl. H04N 1/00

(52) U.S. Cl. 358/403

(57) ABSTRACT

Some demonstrative embodiments of the invention include a method, device and/or system of selectively accessing data. An apparatus able to selectively access classified data, include, according to some demonstrative embodiments of the invention, a storage to store a plurality of encrypted classified files; an encryption module; a secure memory to securely store a plurality of keys to decrypt the classified files and access information related to the classified files; and a controller to selectively enable the encryption module to decrypt a requested file of the classified files using a key of said plurality of keys based on access information related to said requested file. Other embodiments are described and claimed.

### CROSS REFERENCE TO RELATED APPLICATIONS

This application claims priority from U.S. Provisional Application No. 60/670,658, filed Apr. 13, 2005, the entire disclosure of which is incorporated herein by reference.

### BACKGROUND OF THE INVENTION

Conventional computing systems may include a host able to manage a file system including a plurality of files stored by a storage device. The host may implement various cryptographic ciphers, e.g., a cipher according to the Advanced Encryption Standard (AES), to encrypt the files. The encrypted files may be decrypted using a secret key.

The secret key may be internally stored by the host, or received from a user. If internally stored, the secret key may be uncovered without authorization, e.g., by reverse engineering. Conversely, if the secret key is to be provided by the user, the host may have limited “transparency” with respect to other applications.

The system described above may not be applicable, for example, for storing data not owned by the user having the secret key, e.g., because the user may deliberately change the data, e.g., using the secret key. Furthermore, the system may not be applicable for storing data to be selectively accessed by one or more different users, e.g., based on the identity of the user.

Conventional devices for securely storing data may include a “physical” protection structure to prohibit any access to the stored data. However, the protection structure may be relatively complex and/or expensive and, thus, may not provide cost-effective protection for large amounts of data.

### SUMMARY OF SOME DEMONSTRATIVE EMBODIMENTS OF THE INVENTION

Some demonstrative embodiments of the invention include a method, device and/or system of selectively accessing stored data, e.g., a plurality of classified files.

According to some demonstrative embodiments of the invention, a system may include a host to manage a file system including a plurality of encrypted classified files; and a secure control configuration to securely store access information related to the classified files, receive a request from the host to access a requested file of the classified files, and/or selectively enable the host to access the requested file based on the access information.

According to some demonstrative embodiments of the invention, the secure control configuration may include, for example, an encryption module; a secure memory to securely store the access information and a plurality of keys to decrypt the classified; and/or a controller to selectively enable the encryption module to decrypt the requested file using a key of the plurality of keys based on access information related to the requested file.

According to some demonstrative embodiments of the invention, the access information related to the requested file may include identification information identifying one or more authorized users to access the requested file. The controller may selectively provide the key to the encryption module based on a comparison between the identification information and an identity of a user attempting to access the requested file.

According to some demonstrative embodiments of the invention, the access information related to the requested file may include operation information representing one or more authorized operations to be performed by the one or more authorized users. The controller may selectively provide the key to the encryption module based on the operation information. The one or more authorized operations may include, for example, a read operation and/or a write operation. The controller may enable the encryption module to encrypt data to be written to the requested file using the key, e.g., if the one or more authorized operations include a rite operation.

According to some demonstrative embodiments of the invention, the control configuration may include a session memory to securely maintain an identity value representing the user. The controller may selectively enable the encryption module to decrypt the requested file, for example, based on a comparison between the identification information and the identity value.

According to some demonstrative embodiments of the invention, the controller may validate the user and store the identity value in the session memory, e.g., if the user is valid.

According to some demonstrative embodiments of the invention, the secure memory may securely store one or more predetermined integrity values related to one or more of the plurality of classified files, respectively. The one or more predetermined integrity values may include, for example, a stored integrity value related to the requested file. The controller may calculate an integrity value of the requested file, and ensure the integrity of the requested file, e.g., based on a comparison between the calculated integrity value and the stored integrity value related to the file.

According to some demonstrative embodiments of the invention, the controller may securely store in the secure memory a generated key corresponding to a file to be stored in the storage and access information corresponding to the file to be stored; and/or enable the encryption module to encrypt the file to be stored using the generated key. According to some demonstrative embodiments of the invention, the controller may store in the secure memory an integrity value related to the file to be stored.

According to some demonstrative embodiments of the invention, the plurality of keys and the access information may be arranged, for example, in one or more tables including a plurality of records, at least one of the records including a file identification to identify a file of the classified files, access information corresponding to the identified file, and/or a key corresponding to the identified file.

According to some demonstrative embodiments of the invention, the controller may update the access information related to the plurality of files according to access information received from at least one user. The secure memory may securely store, for example, at least one indicator corresponding to at least one respective set of one or more of the classified files, the indicator indicating one or more authorized users to update access information relating to the set of files. The controller may selectively update access information related to a classified file of the set of files with the access information received from the user, e.g. based on the indicator.

According to some demonstrative embodiments of the invention, the requested file may include a file requested by an administrator. The controller may provide the key to the administrator over a secure channel.

According to some demonstrative embodiments of the invention, a method of selectively accessing classified data may include, for example, maintaining a plurality of encrypted classified files; securely maintaining access information related to the classified files and a plurality of keys to decrypt the classified files; and selectively enabling an encryption module to decrypt a requested file of the classified files using a key of the plurality of keys based on access information related to the requested file.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a computing system including a secure storage configuration according to some demonstrative embodiments of the invention;

FIG. 2 is a schematic flowchart of a method of establishing a session according to some demonstrative embodiments of the invention;

FIG. 3 is a schematic flowchart of a method of selectively accessing a secure storage according to some demonstrative embodiments of the invention;

FIG. 4 is a schematic flowchart of a method of updating a secure storage according to some demonstrative embodiments of the invention; and

FIG. 5 is a schematic flowchart of a method of retrieving a securely stored file according to some demonstrative embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art. An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

Embodiments of the present invention may include apparatuses for performing the operations herein. These apparatuses may be specially constructed for the desired purposes, or they may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, a Dynamic RAM (DRAM), a Synchronous DRAM (SD-RAM), a Flash memory, a volatile memory, a non-volatile memory, a cache memory, a buffer, a short term memory unit, a long term memory unit, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

It will be appreciated that the term “preventing unauthorized disclosure of stored data” as used herein may refer to ensuring the stored data may not be understood without authorization, for example, even if access, e.g., partial or complete physical and/or electronic access, to the stored data is obtained. The term “ensuring the integrity of the stored data” as used herein may refer to ensuring, confirming, and/or verifying that the stored data, in part or in whole, has not been manipulated, altered, tampered with, and/or replaced by other data, for example, without authorization and/or in a way which may not be detected, e.g., at a high probability, by an authorized user.

It will be appreciated that the term “securely storing data” as used herein may refer to storing data, while preventing unauthorized disclosure of the stored data and/or ensuring the integrity of the stored data.

The term “classified data” as used herein may refer to data intended to be selectively disclosed and/or accessed based on predetermined access criteria, e.g., user-related access criteria, as described below.

Part of the discussion herein may relate, for demonstrative purposes, to securely storing a data file (“file”). However, embodiments of the invention are not limited in this regard, and may include, for example, securely storing a data block, a data portion, a data sequence, a data frame, a data field, a data record, a content, an item, a message, a key, a code, or the like.

Some demonstrative embodiments of the invention may include a method, device and/or system to selectively access data, e.g., of a plurality of files. For example, a host may manage a file system including, for example, a plurality of encrypted classified files. A secure control configuration may securely store access information related to the classified files. The control configuration may receive a request from the host to access a requested file of the classified files, and selectively enable the host to access the requested file based on the access information, e.g., as described in detail below.

Some demonstrative embodiments of the invention include a method, device and/or system to securely store a classified file, for example, by encrypting and storing the classified file; and selectively enabling decrypting the stored file, based on predetermined access criteria, as described in detail below. Some demonstrative embodiments of the invention may also include determining, before or after encrypting the file, one or more integrity values, e.g., corresponding to the encrypted file; and/or verifying the integrity of the encrypted file, before or after encrypting the file, e.g., using the integrity values, as described below.

According to some demonstrative embodiments of the invention, the access criteria may include user-related access criteria. For example, a stored classified file may be selectively decrypted, based on an identity of a user attempting to access the stored file; and/or a classified file may be encrypted and securely stored based on the identity of a user attempting to store the file, as described below.

According to some demonstrative embodiments of the invention, a file key, e.g., a secret file key, may be used to encrypt the classified file. A different file key may be generated, for example, for one or more stored classified files, e.g., a different secret key may be generated for each classified file. The file key may be securely stored, and may be selectively made available, e.g., based on the access criteria, for decrypting the encrypted file, as described in detail below.

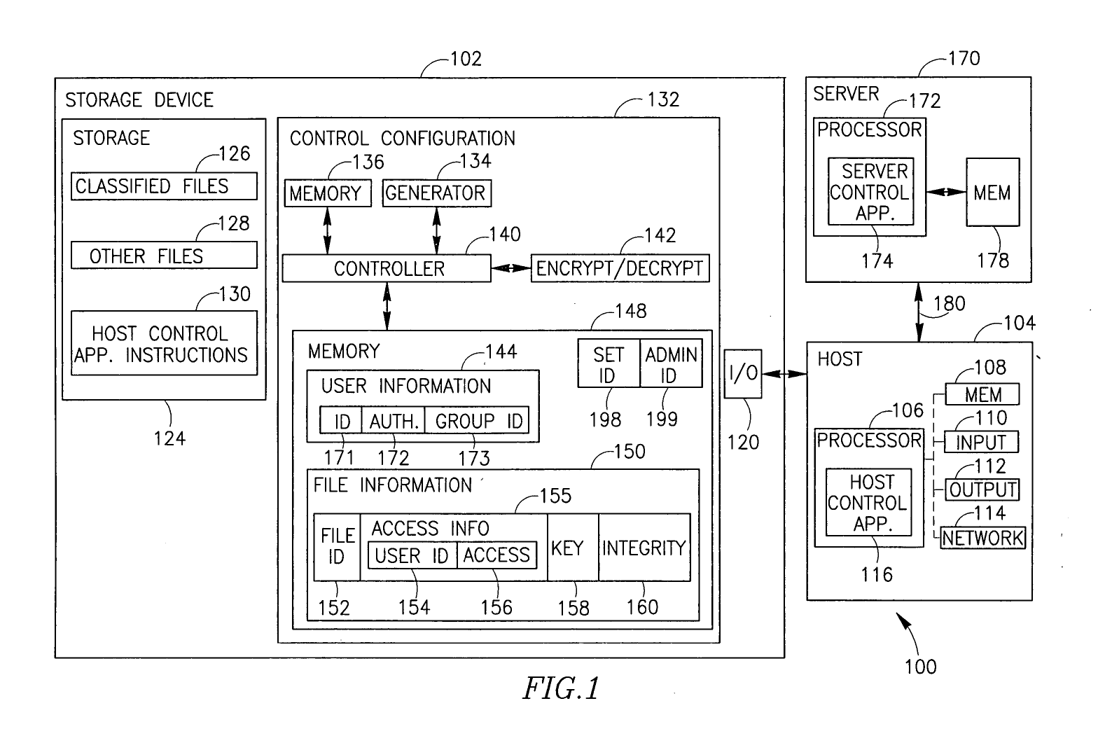

Reference is made to FIG. 1, which schematically illustrates a computing system 100 according to some demonstrative embodiments of the invention.

According to some demonstrative embodiments of the invention, system 100 may include a storage device 102 associated with a host 104, as are both described in detail below.

Although the present invention is not limited in this respect, host 104 may be a portable device. Non-limiting examples of such portable devices include mobile telephones, laptop and notebook computers, personal digital assistants (PDA), and the like. Alternatively, host 104 may be a non-portable device, such as, for example, a desktop computer.

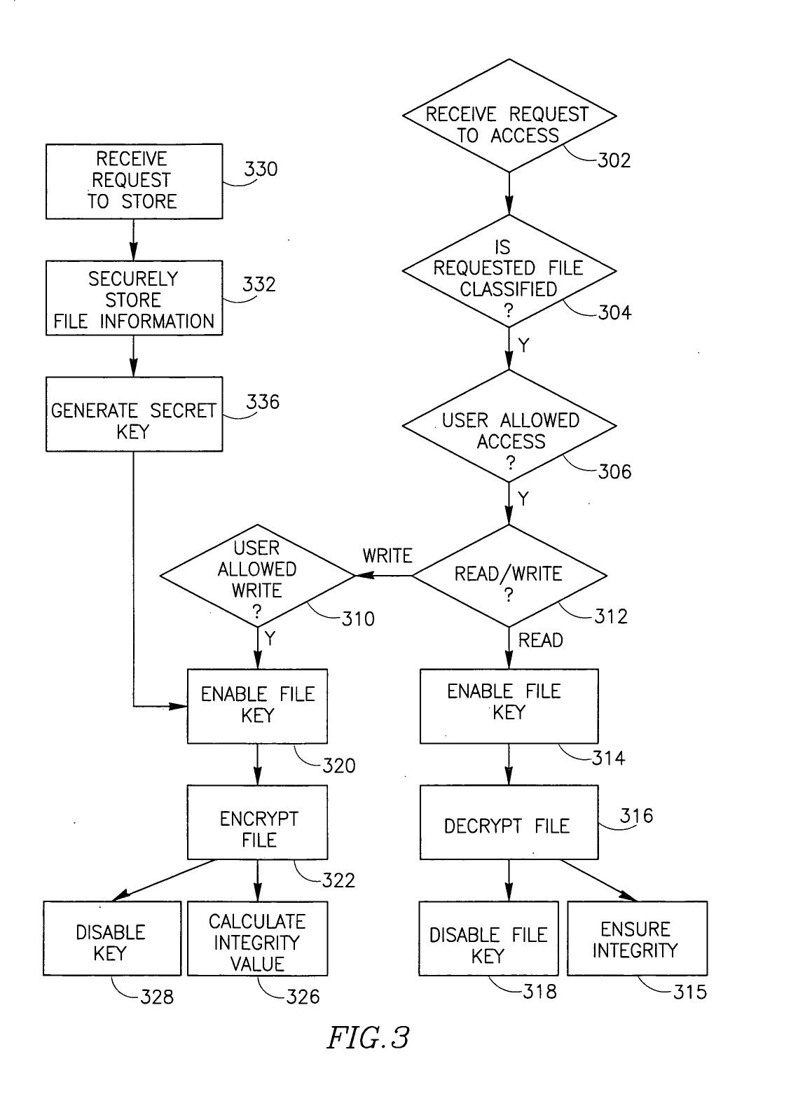

According to the demonstrative embodiments of FIG. 1, host 104 may include a host control application 116 to retrieve one or more stored files, e.g., classified files, from storage device 102, and/or to store one or more files, e.g., classified files, in storage device 102, e.g., as described in detail below with reference to FIG. 3. Host control application 116 may be implemented by any suitable software and/or instructions, which may be executed, for example, by a processor 106 associated with a memory 108. For example, host control application 116 may be implemented by host control application instructions, which may be stored in memory 108 and/or in storage device 102, e.g., as described below. Host 104 may optionally include an output unit 112, an input unit 110, a network connection 114, and/or any other suitable hardware components and/or software components.

According to some demonstrative embodiments of the invention, processor 106 may include a Central Processing Unit (CPU), a Digital Signal Processor (DSP), a microprocessor, a host processor, a plurality of processors, a controller, a chip, a microchip, or any other suitable multi-purpose or specific processor or controller. Input unit 110 may include, for example, a keyboard, a mouse, a touch-pad, or other suitable pointing device or input device. Output unit 112 may include, for example, a Cathode Ray Tube (CRT) monitor, a Liquid Crystal Display (LCD) monitor, or other suitable monitor or display unit. Memory 108 may include, for example, a RAM, a ROM, a DRAM, a SD-RAM, a Flash memory, a volatile memory, a non-volatile memory, a cache memory, a buffer, a short term memory unit, a long term memory unit, or other suitable memory units or storage units. Network connection 114 may be adapted to interact with a communication network, for example, a local area network (LAN), wide area network (WAN), or a global communication network, for example, the Internet. According to some embodiments the communication network may include a wireless communication network such as, for example, a wireless LAN (WLAN) communication network. Although the scope of the present invention is not limited in this respect, the communication network may include a cellular communication network, with host 104 being, for example, a base station, a mobile station, or a cellular handset. The cellular communication network, according to some embodiments of the invention, may be a 3^{rd} Generation Partnership Project (3GPP); such as, for example, Frequency Domain Duplexing (FDD), Global System for Mobile communications (GSM), Wideband Code Division Multiple Access (WCDMA) cellular communication network and the like.

Although the present invention is not limited in this respect, storage device 102 may be a portable storage device, e.g., a portable memory card, a disk, a chip, a token, a smartcard, and/or any other portable storage device, which may be, for example, detachable from host 104. According to other embodiments, storage device 102 may be a non-portable storage device, for example, a memory card, disk, chip and/or any other storage unit or element integrally connected to, or included within, host 104.

According to demonstrative embodiments of the invention, storage device 102 may include a storage module 124 adapted to store data, e.g., one or more classified files, received from processor 106; memory 108; input unit 110; network connection 114; any other suitable component of host 104; and/or any other suitable unit associated with host 104, e.g., as described below.

According to demonstrative embodiments of the invention, storage device 102 may also include a protected control configuration 132, as described below.

According to some demonstrative embodiments of the invention, storage module 124 may include, for example, a RAM, a DRAM, a SD-RAM, a Flash memory, or any other suitable, e.g., non-volatile, memory or storage. Storage module 124 may be able to store at least one classified file 126. Storage module 124 may optionally store one or more other files 128, e.g., non-classified files. For example, storage 124 may store one or more host control application instructions 130, e.g., if storage device 102 is detachable form host 104 and/or instructions 130 are not stored in memory 108.

Although the present invention is not limited in this respect, storage module 124 may be, for example, integrally connected to control configuration 132. According to other embodiments, storage module 124 may be detachable from control configuration 132.

According to demonstrative embodiments of the invention, control configuration 132 may include any suitable protection mechanism, e.g., any suitable “physical” protection structure and/or any other suitable protection configuration as is known in the art, to prevent the disclosure of any part of the contents of configuration 132; to prevent any attempt to access any part of the contents of configuration 132; to prevent any attempt to tamper or alter the contents of configuration 132, in part or in whole; and/or to prevent any attempt to interfere with the operation of configuration 132.

Although the invention is not limited in this respect, according to some demonstrative embodiments of the invention, host 104 may manage a file system including a plurality of encrypted classified files stored by storage 124, e.g., including a classified file 126, as described below. For example, host 104 and/or host control application 106 may implement any suitable management method or algorithm to manage the file system of storage 124, e.g., as is known in the art. Configuration 132 may securely store access information related to the classified files, receive a request from host 104 to access a requested file of said classified files, and selectively enable host 104 to access the requested file based on the access information, e.g., as described in detail below.

According to demonstrative embodiments of the invention, control configuration 132 may selectively encrypt one or more blocks or portions of a file to be stored in storage 124, e.g., based on predefined access criteria, as described below. The encrypted file may be stored in storage 124, e.g., as classified file 126, as described below. Configuration 132 may also be able to selectively decrypt one or more blocks or portions of an encrypted file stored in storage module 124, e.g., classified file 126, for example, based on the predefined access criteria, as described in detail below. Configuration 132 may also be able to ensure the integrity of one or more blocks or portions of classified file 126, as described in detail below. For example, control configuration 132 may encrypt blocks and/or portions of a file while the file is being stored in storage 124, e.g., by host 104; and/or decrypt blocks and/or portions of a stored file while the file is being retrieved from storage 124. e.g., by host, 104, as described below.

According to some demonstrative embodiments of the invention, configuration 132 may include a controller 140, a memory 148, an encryption/decryption module 142, a key generator 134, and a memory 136, as are all described in detail below.

According to some demonstrative embodiments of the invention, encryption/decryption module 142 may include any suitable hardware and/or software, e.g., an encryption/decryption engine as is known in the art, able to encrypt a file to be stored in storage module 124, and/or to decrypt a file from storage module 124, e.g., as described below. For example, module 142 may implement an Advanced Encryption Standard (AES) cipher, e.g., an AES-CTR cipher algorithm, or any other suitable encryption/decryption algorithms as are known in the art.

According to some demonstrative embodiments of the invention, key generator 134 may include any suitable hardware and/or software able to generate, e.g., randomly or substantially randomly, a secret file key, i.e., a block of bits of a predetermined length, e.g. 128 bits, corresponding, for example, to the cipher algorithm implemented by encryption/decryption module 142. Key generator 134 may optionally be able to generate an Initialization Vector (IV), e.g., as is known in the art.

According to some demonstrative embodiments of the invention, memory 148 may include, for example, a RAM, a DRAM, an SD-RAM, a Flash memory, or any other suitable non-Volatile, memory or storage. According to some demonstrative embodiments, storage 124 may be able to store a relatively large amount of data, e.g., compared to the amount of data that may be stored in memory 148.

According to some demonstrative embodiments of the invention, memory 148 may store user information 144 corresponding to one or more users (hereinafter “valid users”) allowed to access one or more classified files 126. Although the invention is not limited in this respect, user information 144 may be stored, for example, in the form of at least one table including one or more user IDs 171, and/or user authentication information 172 for authenticating a user identifying by user ID 171. In one non limiting example, user ID 171 may include a username, and user authentication information 172 may include a password, as are known in the art. Any other suitable user ID and/or user authentication information, e.g., one or more digital certificates and/or shared keys, may be implemented additionally or alternatively for identifying and/or authenticating a user.

According to some demonstrative embodiments of the invention, memory 148 may also store file information 150 corresponding to one or more files stored in storage 124, e.g., classified file 126. Although the invention is not limited in this respect, file information 150 may be stored, for example, in the form of a table including one or more records, e.g., including a file ID 152, access information 155, a secret file key 158, and/or integrity information 160. File information 150 may additionally or alternatively include any other desired information, e.g., an IV, which may be implemented by a desired encryption/decryption scheme and/or integrity scheme. File ID 152 may include a value for identifying classified file 126, e.g., a value corresponding to an identifier, which may identify the location of file 126 in storage 124 using, for example, a File Allocation Table (FAT) as is known in the art. For example, file ID 152 may include a “file handle” corresponding to file 126, as is known in the art. Access information 155 may include access definitions related to one or more users, authorized to access classified file 126 (“hereinafter authorized users”), and/or to one or more operations the authorized users may perform on the file. For example, access information 155 may include at least one authorized user ID 154, e.g., a user name, allowed to access the file identified by file ID 152; and one or more authorized operations 156, e.g., read and/or write operations, the authorized user may perform on the file identified by file ID 152. According to some demonstrative embodiments, access information 155 may include different access definitions for different users. For example, one or more users may be authorized to only read a file, whereas one or more other users may be authorized to perform read and write operations on the file.

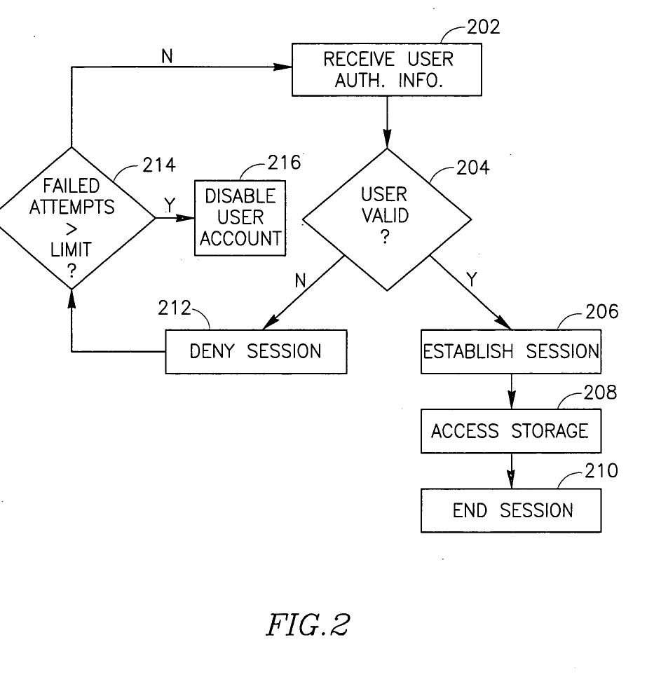

According to some demonstrative embodiments of the invention, memory 136 may include a RAM or any other suitable volatile memory, to store a value corresponding to the identity of a valid user during a session, as described below with reference to FIG. 2.

According to some demonstrative embodiments of the invention, one or more authorized users may be grouped into one or more user-groups according to any suitable criteria. For example, the authorized users may be grouped into one or more user-groups according to the access criteria, e.g., such that all the users of a user-group have the same access definitions. According to these demonstrative embodiments, user information 144 may also include a group ID 173 identifying one or more users as belonging to a user-group. Accordingly, access information 155 may include a group ID, e.g., instead of or in addition to user ID 154, identifying one or more user-groups authorized to access a file.

According to some demonstrative embodiments of the invention, key 158 may include a key and/or any other suitable authentication information, e.g., an IV, which may be generated, e.g., by generator 134, with relation to a classified file identified by file ID 152.

According to some demonstrative embodiments of the invention, integrity information 160 may include any suitable information to verify the integrity of file 126. For example, integrity information 160 may include a Message Authentication Code (MAC), which may be derived, for example, from key 158 and file 126, e.g., using a hash algorithm, a block cipher algorithm, such as, for example, a CBC-MAC algorithm, and/or any other suitable method as known in the art. Integrity information 160 may include any other suitable integrity information, e.g., a Hash value or a secure checksum value, as are known in the art.

According to some demonstrative embodiments of the invention, controller 140 may include a CPU, a DSP, a microprocessor, a host processor, a plurality of processors, a chip, a microchip, or any other suitable multi-purpose or specific processor or controller.

According to some demonstrative embodiments of the invention, controller 140 may determine whether a user attempting to access storage 124, e.g., a user of host 104 and/or any other device, is a valid user, and to establish a session corresponding to a user determined as valid, as described below with reference to FIG. 2.

According to some demonstrative embodiments of the invention, during a session, controller 140 may be able to selectively allow the user to perform one or more operations on a requested file stored in storage 124, e.g., based on the access information corresponding to the requested file, and/or the identity of the user, as described below with reference to FIG. 3.

Aspects of the invention are described herein in the context of demonstrative embodiments of a controller, e.g., controller 140, a key generator, e.g., generator 134, a memory, e.g., memory 136, and/or an encryption/decryption module, e.g., encryption/decryption module 142, which may be implemented as separate modules of a control configuration, e.g., configuration 132. However, it will be appreciated by those skilled in the art that, according to other embodiments of the invention, the controller, the key generator, the memory, and/or the encryption/decryption module may be implemented in any desired combination, e.g., as a single control module.

According to some demonstrative embodiments of the invention, storage arrangement 102 may additionally include an input/output interface 120 to receive, e.g., from host 104, a one or more portions or blocks of a file to be stored in storage module 124, and to provide the portions or blocks of the file to storage control configuration 132 and/or storage 124 in a suitable format, e.g., as is known in the art. Interface 120 may also be able to receive from storage control configuration 132 and/or storage 124 one or more portions or blocks of a file, retrieved from storage module 124, and provide the portions or blocks of the file to host 104 in a suitable format, e.g., as is known in the art. Interface 120 may also be able to transfer any other desired data and/or information, e.g., user information, between host 104 and a desired module of configuration 132, e.g., controller 140, and/or storage module 124. Interface 120 may include any suitable hardware and/or software, e.g., as known in the art.

According to some demonstrative embodiments of the invention, system 100 may also include a server 170, e.g., a remote server, associated with host 104, for example, via a wired or wireless connection 180. Server 170 may include a server control application 174 to securely perform one or more operations on data stored in memory 148 and/or to securely access one or more files stored in memory 124, e.g., as described below. According to some demonstrative embodiments of the invention, server control application 174 may be implemented by any suitable instructions, which may be executed, for example, by a processor 172 associated with a memory 178. Processor 172 may include, for example, a Central Processing Unit (CPU), a Digital Signal Processor (DSP), a microprocessor, a host processor, a plurality of processors, a controller, a chip, a microchip, or any other suitable multi-purpose or specific processor or controller.

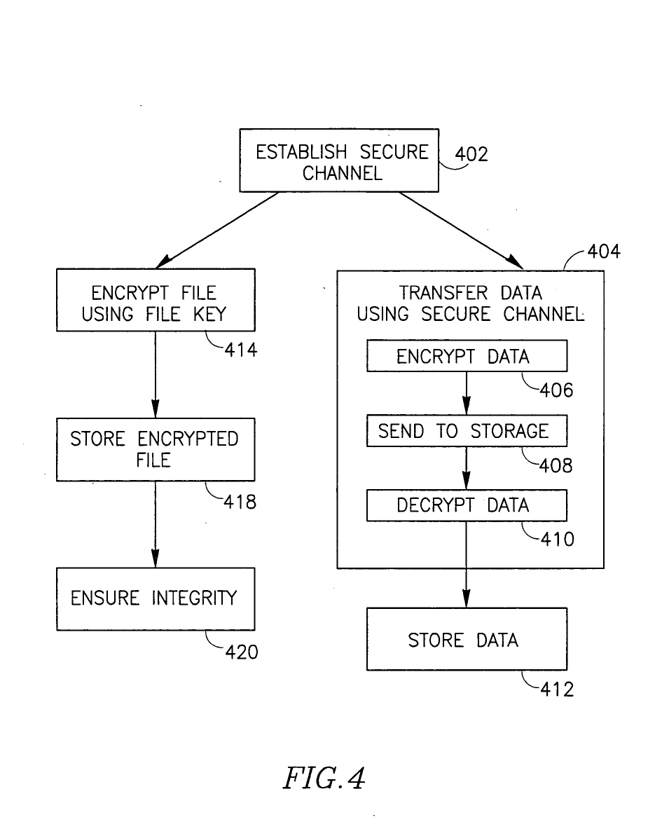

According to some demonstrative embodiments of the invention, server control application 174 may securely store one or more files in storage 124; and/or securely perform one or more operations on user information 144 and/or file information 150, e.g., as described below with reference to FIG. 4. For example, server control application 174 may be used by a system administrator (hereinafter “the administrator”) to securely modify user information 144, for example, by adding, deleting and/or updating information corresponding to the valid users.

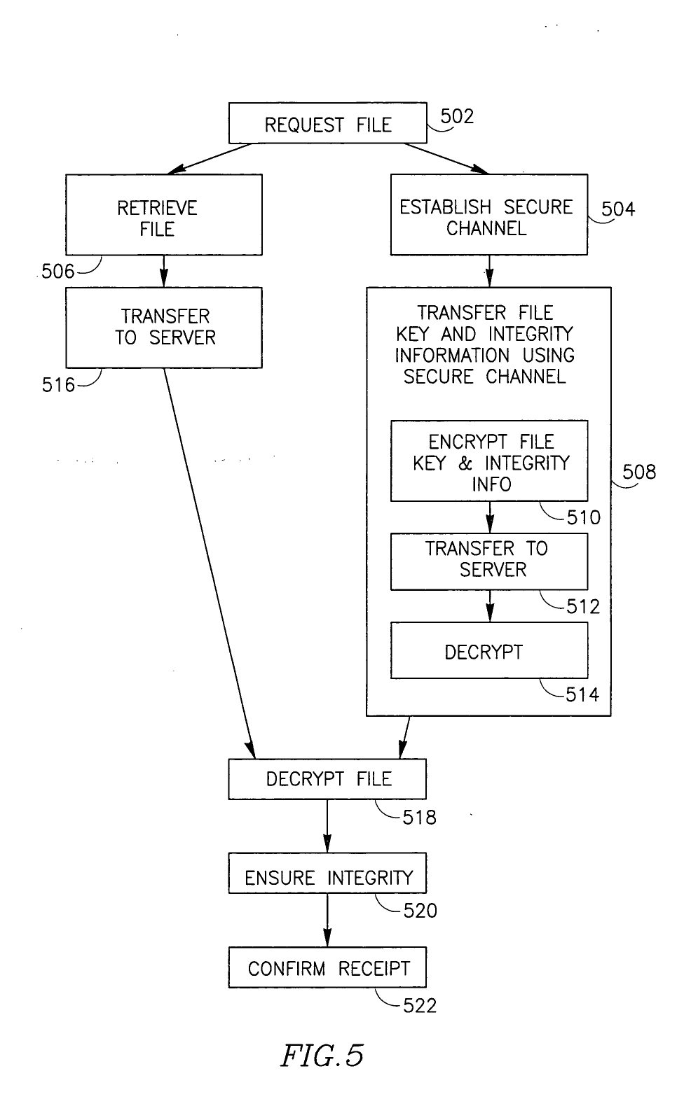

According to some demonstrative embodiments of the invention, server control application 174 may securely retrieve one or more classified files, e.g., file 126, stored in storage 124, as described below with reference to FIG. 5.

According to some demonstrative embodiments of the invention, control configuration 132 may include a memory, e.g., memory 148, to store user information, e.g., user information 144, and/or file information, e.g., file information 150, as described above. However, according to other embodiments of the invention, any other suitable configuration may be implemented for storing at least part of the user information and/or the file information. For example, storage 124 and/or controller 140 may be adapted, using any suitable method and/or configuration, e.g., as known in the art, to enable securely storing at least part of the user information and/or file information in storage 124.

Some demonstrative embodiments of the invention may relate to a memory, e.g., memory 148, to store a table including file information, e.g., file information 150, and/or a table including user information, e.g., user information 144, relating to a plurality of classified files, e.g., files 126; and/or a server control application, e.g., server control application 174 to enable a system administrator to securely modify the user information an/or the file information. However, it will be appreciated by a person of ordinary skill in the art that the invention is not limited in this respect, and that in other embodiments of the invention the user information and/or file information may be stored in any other suitable configuration and/or arrangement. For example, in one embodiment the user information and/or file information may be stored in a plurality of tables, e.g., a tree of tables. Controller 140 may selectively enable one or more authorizes users and/or administrators to access one or more of the plurality of tables, e.g., based on an identity of the users and/or administrators. For example, secure memory 148 may securely store at least one indicator 199 corresponding to at least one respective set identifier 198 identifying a set, e.g., a table, of one or more of classified files 126. Indicator 199 may indicate, for example, one or more authorized users and/or administrators to access and/or update file information 150 and/or user information 144 corresponding to one or more files of the set indicated by indicator 198. Controller 140 may selectively enable a user or administrator to update, delete, add and/or store information 150 and/or information 144 of one or more files of the set of files indicated by identifier 198, based on indicator 199. For example, controller 140 may selectively enable the user or administrator to update access information 150 and/or user information 144 based on indicator 199, e.g., by comparing indicator 199 to an identity of the user and/or administrator. In one non-limiting example, the administrator may generate one or more sub-tables or sub-sets of files to be selectively accessed by one or more users defined by the administrator. For example, a user or administrator may define a table, e.g., an “empty” table, to be accessed by one or more predefined users. The predefined users may then store one or more files in storage 124 and update the table, access information 150 and/or user information 144, based on the stored files.

Reference is also made to FIG. 2, which schematically illustrates a method of establishing a session according to some demonstrative embodiments of the invention.

Although the present invention is not limited in this respect, the method of FIG. 2 may be implemented by system 100 (FIG. 1), host 104 (FIG. 1), control configuration 132 (FIG. 1), and/or controller 140 (FIG. 1), e.g., to selectively establish a session, e.g., a user session with a user of host 104 (FIG. 1).

As indicated at block 202, the method may include receiving user information corresponding to a user attempting to establish a session, for example, for accessing one or more files of storage 124 (FIG. 1), e.g., classified files 126 (FIG. 1). The user information may include any suitable information, for example, a user ID and user authentication information, e.g., a password, for identifying and/or authenticating the user. For example, host control application 116 (FIG. 1) may implement a suitable user interface for receiving the user information. The user interface may include, for example, a Graphical User Interface (GUI) as is known in the art. Controller 140 (FIG. 1) may receive the user information from host control application 116 (FIG. 1), e.g., via interface 120 (FIG. 1). The user information may include any other desired information, e.g., one or more digital certificates, for authenticating and/or identifying the user.

As indicated at block 204, the method may include validating the user, for example, by comparing between the received user information and user information of one or more valid users stored in memory 148 (FIG. 1). For example, controller 140 (FIG. 1) may be able to compare between the received user ID and one or more user IDs 171 (FIG. 1); and, if the received user ID matches stored user ID 171, to compare the received authentication information to stored authentication information 172. Controller 140 (FIG. 1) may determine the user is valid if, for example, the received user ID matches one of the stored user IDs, and the received authentication information matches the stored authentication information. Controller 140 (FIG. 1) may determine the user is not valid if, for example, the received user ID and/or the received authentication information do not match the stored user ID and/or authentication information. Any, other identification and/or authentication scheme, e.g., a scheme using digital certificates, may be implemented by host 106 (FIG. 1) and/or control configuration 132 (FIG. 1) to identify, authenticate and/or validate the user.

As indicated at block 212, the method may include preventing (denying) access to one or more files of storage 124 (FIG. 1), e.g., classified files 126 (FIG. 1), by denying a session, for example, if the user is determined to be not valid. This may be achieved, for example, by ensuring that memory 136 (FIG. 1) does not contain a value corresponding to the user ID. Controller 140 (FIG. 1) may be able, for example, to provide host control application 116 (FIG. 1) with an indication that the user attempting to access storage 124 (FIG. 1) was determined to be not valid. Host control application 116 (FIG. 1) may inform the user that the attempt to access storage 124 (FIG. 1) has failed. Host control application 116 (FIG. 1) may also be able, for example, to prompt the user to re-enter the user information, e.g., in order to re-attempt accessing storage 124 (FIG. 1).

According to some demonstrative embodiments of the invention, the user identified by the user ID may be prevented (disabled) from establishing a session, e.g., after a predefined limit number of failed attempts to establish a session for the same user ID. For example, the method may include determining whether the number of failed attempts is equal to the limit number, as indicated at block 214. As indicated at block 216, the method may include preventing a user identified by the user ID from establishing a session, e.g., if the number of failed attempts is determined to be equal to the limit number. In some embodiments, a counter value corresponding to the number of failed attempts may be stored in memory 148, for example, as part of access information 155.

As indicated at block 206, the method may include establishing a session, e.g., if the user is determined to be valid. For example, controller 140 (FIG. 1) may store in memory 136 (FIG. 1) a value corresponding to the user, e.g., the user ID or a group ID corresponding to the user.

As indicated at block 208, the method may include selectively accessing one or more of files 126 (FIG. 1) during the session, e.g., as described below with reference to FIG. 3.

As indicated at block 210, the method may include terminating the session, e.g., by deleting user from memory 136. For example, controller 140 (FIG. 1) may delete the contents of memory 136 (FIG. 1), e.g., in response to a “log-out request” received from host control application 116 (FIG. 1), or if communication between controller 140 (FIG. 1) and host control application 116 (FIG. 1) is terminated. Additionally or alternatively, the contents of memory 136 (FIG. 1) may be deleted, for example, if no power is supplied to memory 136 (FIG. 1).

Reference is made to FIG. 3, which schematically illustrates a method of selectively accessing a secure storage in accordance with some demonstrative embodiments of the invention. Although the present invention is not limited in this respect, the method of FIG. 3 may be implemented by system 100 (FIG. 1), host 104 (FIG. 1), control configuration 132 (FIG. 1), and/or controller 140 (FIG. 1), e.g., to selectively access storage 124 (FIG. 1).

Although the invention is no limited in this respect, selectively accessing a secure storage may include, for example, selectively accessing one or more classified files stored in the secure storage, as described in detail below.

As indicated at block 302, the method may include receiving a request to access a classified file stored in the secure storage. For example, a user of host 104 (FIG. 1) may attempt, e.g., using host control application 116 (FIG. 1), to access a requested file of classified files 126 (FIG. 1), for example, during the user session. Controller 140 (FIG. 1) may receive from host control application 116 (FIG. 1) the request, which may include, for example, a requested file ID.

As indicated at block 304, the method may include determining whether the requested file is or includes a classified file. For example, controller 140 (FIG. 1) may determine whether the requested file is stored as a classified file by determining whether the requested file ID matches one of file IDs 152 (FIG. 1).

As indicated at block 306, the method may include determining whether the user of a current session (“the currently logged on user”) is allowed to access the requested file, e.g., if the requested file is determined to be stored as a classified file. For example, controller 140 (FIG. 1) may determine whether the user is allowed to access the requested file, by determining whether the user ID, e.g., as stored in memory 136 (FIG. 1), matches the access information, e.g., user ID 154 (FIG. 1), corresponding to the requested file ID, e.g., file ID 152 (FIG. 1).

As indicated at block 312, the method may include determining the type of operation, e.g., a read operation or a write operation, the user is attempting to perform on the requested file. For example, controller 140 (FIG. 1) may determine the type of operation the user is attempting to perform on the requested file based on the request received from host control application 116 (FIG. 1).

As indicated at block 314, the method may include enabling the secret file key corresponding to the requested file to decrypt the requested file, e.g., if the requested operation is a read operation. For example, controller 140 (FIG. 1) may switch module 142 (FIG. 1) to a decrypting mode of operation, and may provide module 142 (FIG. 1) with key 158 (FIG. 1) corresponding to the requested file ID.

As indicated at block 316, the method may include decrypting the requested file, e.g., while retrieving the requested file from storage 124 (FIG. 1). For example, host control application 116 (FIG. 1) may retrieve the requested file from storage 124 (FIG. 1), e.g., using any suitable file retrieving algorithm, and module 142 (FIG. 1) may decrypt the requested file, e.g., as it is being retrieved by host control application 116 (FIG. 1).

As indicated at block 318, the method may include disabling the secret file key corresponding to the requested file, for example, after retrieving the requested file, or if the retrieving process is interrupted, e.g., if the session is terminated.

As indicated at block 315, the method may optionally include ensuring the integrity of the requested file. For example, controller 140 may calculate an integrity value, e.g., a MAC value, a Hash value, a secure checksum value, and/or any other suitable integrity value, corresponding to the requested file, e.g., as it is being retrieved from storage 124 (FIG. 1). Controller 140 (FIG. 1) may also be able to compare between the calculated integrity value of the retrieved file and a stored integrity value corresponding to the retrieved file, e.g., value 160 (FIG. 1). Controller 140 (FIG. 1) may notify host control application 116 (FIG. 1) whether the integrity of the retrieved file has been ensured. Alternatively, the integrity value may be calculated by any other suitable module. For example, encryption/decryption module 142 may be adapted to calculate the integrity value.

As indicated at block 310, the method may include determining whether the user is authorized to perform a write operation to the requested file. For example, controller 140 (FIG. 1) may determine whether the user is authorized to perform a write operation to the requested file based on the access information, e.g., based on access information 155 (FIG. 1) corresponding to user ID 154 (FIG. 1).

As indicated at block 320, the method may include enabling the key corresponding to the requested file to encrypt the requested file, e.g., if the user is determined to be authorized to write to the requested file. For example, controller 140 (FIG. 1) may switch module 142 (FIG. 1) to an encrypting mode of operation, and provide module 142 (FIG. 1) with key 158 (FIG. 1) corresponding to the requested file ID.

As indicated at block 322, the method may include encrypting the requested file. e.g., while writing the requested file to storage 124 (FIG. 1). For example, host control application 116 (FIG. 1) may write the requested file to storage 124 (FIG. 1), e.g., using any suitable write-to-file algorithm. Module 142 (FIG. 1) may encrypt the file, e.g., during the write operation.

As indicated at block 326, the method may optionally include calculating an integrity value, e.g., a MAC value, a Hash value, a secure checksum value, or any other suitable integrity value, related to the requested file. For example, controller 140 (FIG. 1) may calculate the integrity value corresponding to the requested file, e.g., as it is being encrypted by module 142 (FIG. 1). Alternatively, the integrity value may be calculated by any other suitable module. For example, encryption/decryption module 142 may be adapted to calculate the integrity value. Controller 140 (FIG. 1) may store the calculated MAC value as MAC value 160 (FIG. 1) corresponding to the requested file.

As indicated at block 328, the method may include disabling the use of the secret file key corresponding to the requested file, for example, after completely encrypting the requested file, or if the writing operation is interrupted, e.g., if the session is terminated.

Although the invention is not limited in this respect, according to some demonstrative embodiments of the invention, selectively accessing a secure storage may include selectively storing one or more classified files in the secure storage, as described below.

As indicated at block 330, the method may include receiving a request to securely store a classified file in storage 124 (FIG. 1). For example, the user of host 104 (FIG. 1) may attempt, e.g., using host control application 116 (FIG. 1), to securely store a file in storage 124 (FIG. 1), e.g., during the user session. Controller 140 (FIG. 1) may receive from host control application 116 (FIG. 1) the request, which may include, for example, a file ID and access information corresponding to the file to be stored.

As indicated at block 332, the method may include securely storing the received file ID and the received access information. For example, controller 140 (FIG. 1) may store in memory 148 (FIG. 1) the received file ID of the file to be stored, e.g., as file ID 152 (FIG. 1); and the received access information, e.g., as access information 155 (FIG. 1).

As indicated at block 336, the method may include generating a secret file key corresponding to the file to be stored. For example, controller 140 (FIG. 1) may cause generator 134 (FIG. 1) to generate a secret file key. Controller may also store the generated file key in storage 148 (FIG. 1), e.g., as key 158 (FIG. 1), corresponding to the file ID of the file to be stored.

The method may also include securely storing the file, e.g., by enabling the secret file key for encrypting the file; encrypting the file as it is stored in storage 124 (FIG. 1), calculating an integrity value corresponding to the encrypted file; and/or disabling the use of the secret file key, e.g., as described above with reference to blocks 320, 322, 326 and/or 328.

According to some demonstrative embodiments of the invention, file information 150 may be modified according to any suitable authorization scheme. For example, the authorization scheme may be adapted to enable one or more users, e.g., any user, to add a new record, e.g., including a new file ID 152 and corresponding access information; and/or to delete an entire record corresponding to a file ID. Additionally or alternatively, the authorization scheme may be adapted to enable one or more users to selectively modify access information 156. For example, access information 156 may include authorization information corresponding to one or more users authorized to modify access information 156. Additionally or alternatively, the authorization scheme may be adapted to enable one or more users, e.g., any user, to add a new record, e.g., including a new user ID 171 and corresponding user information, for example, only if the currently stored user information 144 does not already include the new user ID.

According to some demonstrative embodiments of the invention, the file information and the file to be stored may be provided by the user during the same session. Accordingly, one or more of the operations described with reference to blocks 330, 332, 336, 320, 322, 326 and 328 may be performed during the same session.

According to other demonstrative embodiments of the invention, the file information may be provided during a first session, and the file to be stored may be provided during a second session. The file information may be provided by the same user providing the file information or by another user satisfying the conditions of access information 155 (FIG. 1). According to these demonstrative embodiments, one or more of the operations described above with reference to blocks 330, 332, and 336, may be performed during the first session; and one or more of the operations described above with reference to blocks 320, 322, 326 and 328, may be performed during the second session.

It will be appreciated by those skilled in the art that any combination of the actions described above with reference to FIG. 3, may be implemented for selectively accessing a secure storage according to embodiments of the invention. Further, other actions or series of actions may be used.

Reference is made to FIG. 4, which schematically illustrates a method of updating a secure storage according to some demonstrative embodiments of the invention.

Although the present invention is not limited in this respect, the method of FIG. 4 may be implemented by system 100 (FIG. 1), control configuration 132 (FIG. 1), controller 140 (FIG. 1), host 104 (FIG. 1), server 170 (FIG. 1), and/or server control application 174 (FIG. 1) to securely store one or more files in storage 124 (FIG. 1), and/or to securely perform one or more operations on the contents of memory 148 (FIG. 1), e.g., to update user information 144 (FIG. 1) and/or file information 150 (FIG. 1).

As indicated at block 402, the method may include establishing a secure channel between a server, e.g., server 170 (FIG. 1), and a control configuration of a secure storage, e.g., control configuration 132 (FIG. 1). The secure channel may be established by server control application 174 (FIG. 1) directly communicating with control configuration 132 (FIG. 1), or by server control application 174 (FIG. 1) communicating with control configuration 132 (FIG. 1) via host control application 116 (FIG. 1). The secure channel may be established using any suitable method and/or algorithm for establishing a secure channel over a communication channel, e.g., using a shared session key as is known in the art.

As indicated at block 404, the method may include transferring information from the server to the secure storage using the secure channel. For example, server control application 174 (FIG. 1) may use the established secure channel to transfer to controller 140 (FIG. 1) user information and/or file information for updating memory 148 (FIG. 1).

As indicated at block 404 transferring the data using the secure channel may include encrypting the information to be transferred. For example, server control application 174 (FIG. 1) may encrypt the user information and/or file information using the shared session key. The method may also include, transferring the encrypted information to the storage device, as indicated at block 408. As indicated at block 410 transferring the data using the secure channel may also include decrypting the encrypted information. For example, controller 140 (FIG. 1) may control encryption/decryption module 142 (FIG. 1) to decrypt the encrypted user information and/or file information using the shared session key.

As indicated at block 412, the method may also include storing the information received via the secure channel. For example, controller 140 (FIG. 1) may update user information 144 (FIG. 1) and/or file information 150 (FIG. 1), based on the information received from server control application 174 (FIG. 1).

According to some demonstrative embodiments of the invention, the method of FIG. 4 may be implemented, e.g., by the administrator, to securely store a file as classified file 126 (FIG. 1) using server control application 174 (FIG. 1). According to these embodiments, server control application 174 (FIG. 1) may update memory 148 (FIG. 1) to include a file ID, a secret file key generated by server control application 174 (FIG. 1), access information, and/or integrity information corresponding to the file to be saved, e.g., as described above with reference to blocks 402, 404 and/or 412. Server control application 174 (FIG. 1) may then transfer to storage 102 the file to be stored, e.g., as described below.

As indicated at block 414 the method may include, encrypting the file to be stored, using the secret file key. For example, server control application 174 (FIG. 1) may control encryption/decryption module 142 (FIG. 1) to encrypt the file to be stored using the generated secret file key, e.g., after transferring the secret file key to controller 140 (FIG. 1).

As indicated at block 418, the method may include storing the encrypted file in the secure storage configuration. For example, server control application 174 (FIG. 1) may transfer the encrypted file to host application 116 (FIG. 1), e.g., via connection 180 (FIG. 1). Host application 116 (FIG. 1) may store the encrypted file in storage 124 (FIG. 1), e.g., as classified file 126 (FIG. 1). Alternatively, storage 124 (FIG. 1) may be adapted to enable directly storing the encrypted file in storage 124 (FIG. 1), e.g., using host application 116 (FIG. 1) as a “gateway”.

As indicated at block 420, the method may optionally include ensuring the integrity of the received encrypted file. For example, controller 140 (FIG. 1) may calculate an integrity value, e.g., a MAC value, a Hash value, a secure checksum and/or any other suitable integrity value, related to the received encrypted file. Controller 140 (FIG. 1) may compare between the calculated integrity value and stored integrity value 160 (FIG. 1) corresponding to the file ID of the received file. The integrity of the received file may be ensured, e.g., if the calculated integrity value matches stored integrity value 160 (FIG. 1). Controller 140 (FIG. 1) may notify server control application 174 (FIG. 1), e.g., using host control application 116 (FIG. 1), whether or not the integrity of the retrieved file is has been ensured.

It will be appreciated by those skilled in the art that any combination of the actions described above with reference to FIG. 4, may be implemented to update a secure storage according to embodiments of the invention. Further, other actions or series of actions may be used.

Reference is made to FIG. 5, which schematically illustrates a method of retrieving a securely stored file according to some demonstrative embodiments of the invention.

Although the present invention is not limited in this respect, the method of FIG. 5 may be implemented by system 100 (FIG. 1), control configuration 132 (FIG. 1), server 170 (FIG. 1), host 104 (FIG. 1), and/or server control application 174 (FIG. 1) to securely retrieve one or more files from storage 124 (FIG. 1).

As indicated at block 502, the method may include requesting a file to be retrieved. For example, the administrator may use server control application 174 (FIG. 1) to request, e.g., from host control application 116 (FIG. 1), the retrieving of a securely stored file, e.g., file 126 (FIG. 1). Host control application 116 (FIG. 1) may pass the request to controller 140 (FIG. 1).

As indicated at block 504, the method may include establishing a secure channel between server control application 174 (FIG. 1) and controller 140 (FIG. 1), e.g., as described above with reference to block 402 (FIG. 4).

As indicated at block 508, the method may include transferring the file key and/or integrity information corresponding to the requested file, to server control application 174 (FIG. 1), e.g., via the secure channel. For example, the method may include encrypting file key 158 (FIG. 1) and integrity information 160 (FIG. 1), e.g., using the shared session key or any other key implemented by the secure channel, as indicated at block 510. The method may also include transferring the encrypted file key and integrity information to server control application 174 (FIG. 1), as indicated at block 512. The method may also include decrypting the encrypted file key and integrity information, as indicated at block 514. For example, server control application 174 (FIG. 1) may decrypt the encrypted file key and integrity information, e.g., using the shared session key.

As indicated at block 506, the method may also include retrieving the requested file. For example, host control application 116 (FIG. 1) may retrieve the requested file from storage 124 (FIG. 1). It will be noted that the retrieved file may be encrypted by secret file key 158 (FIG. 1).

As indicated at block 516, the method may include transferring the retrieved file to the server. For example, host control application 116 (FIG. 1) may transfer the retrieved file to server control application 174 (FIG. 1), e.g., via connection 180 (FIG. 1).

As indicated at block 518, the method may include decrypting the retrieved file, e.g., using the secret file key. For example, server control application 174 (FIG. 1) may control encryption/decryption module 142 to decrypt the retrieved file using file key 158 (FIG. 1), which may be received via the secure channel.

As indicated at block 520, the method may include ensuring the integrity of the retrieved file. For example, server control application 174 (FIG. 1) may calculate an integrity value related to the retrieved file. Server control application may compare the calculated integrity value to integrity information 160 (FIG. 1) received via the secure channel. The integrity of the retrieved file may be ensured, e.g., if the calculated integrity value matches the received integrity value.

As indicated at block 522, the method may include confirming the successful receipt of the retrieved file. For example, server control application 174 (FIG. 1) may be able to notify controller 140 (FIG. 1), e.g., using the secure channel, whether or not the retrieved file has been received and/or whether the integrity of the retrieved file is has been ensured.

It will be appreciated by those skilled in the art that any combination of the actions described above with reference to FIG. 5, may be implemented to retrieve a securely stored file according to embodiments of the invention. Further, other actions or series of actions may be used.

According to Other demonstrative embodiments of the invention, the method of retrieving the securely stored file may include transferring the requested file to the server, e.g., using the secure channel, after decrypting the requested file. For example, secret key 158 (FIG. 1) may be provided to module 142 (FIG. 1) for decrypting the requested file. The decrypted file may then be transferred to server control application 174 (FIG. 1) via the secure channel.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. An apparatus to selectively access classified data, the apparatus comprising:
a storage to store a plurality of encrypted classified files;
an encryption module;
a secure memory to securely store a plurality of keys to decrypt said classified files and access information related to said classified files; and
a controller to selectively enable said encryption module to decrypt a requested file of said classified files using a key of said plurality of keys based on access information related to said requested file.

2. The apparatus of claim 1, wherein the access information related to the requested file includes identification information identifying one or more authorized users to access the requested file, and wherein said controller is able to selectively provide said key to said encryption module based on a comparison between said identification information and an identity of a user attempting to access said requested file.

3. The apparatus of claim 2, wherein the access information related to the requested file includes operation information representing one or more authorized operations to be performed by said one or more authorized users, wherein said controller is able to selectively provide said key to said encryption module based on said operation information.

4. The apparatus of claim 3, wherein said one or more authorized operations include at least one operation selected from the group consisting of a read operation and a write operation.

5. The apparatus of claim 3, wherein said controller enables said encryption module to encrypt data to be written to said requested file using said key, if said one or more authorized operations include a write operation.

6. The apparatus of claim 2 comprising a session memory to securely maintain an identity value representing said user, wherein said controller selectively enables said encryption module to decrypt said requested file based on a comparison between said identification information and said identity value.

7. The apparatus of claim 6, wherein said controller is able to validate said user and store said identity value in said session memory if said user is valid.

8. The apparatus of claim 1, wherein said secure memory securely stores one or more predetermined integrity values related to one or more of said plurality of classified files, respectively.

9. The apparatus of claim 8, wherein the one or more predetermined integrity values include a stored integrity value related to said requested file; and wherein said controller is able to calculate an integrity value of said requested file, and ensure the integrity of said requested file based on a comparison between the calculated integrity value and the stored integrity value related to said file.

10. The apparatus of claim 1, wherein said controller is able to:
securely store in said secure memory a generated key corresponding to a file to be stored in said storage and access information corresponding to the file to be stored; and
enable said encryption module to encrypt the file to be stored using said generated key.

11. The apparatus of claim 10, wherein said controller is able to store in said secure memory an integrity value related to the file to be stored.

12. The apparatus of claim 1, wherein said plurality of keys and said access information are arranged in one or more tables including a plurality of records, at least one of said records including a file identification to identify a file of said classified files, access information corresponding to the identified file, and a key corresponding to the identified file.

13. The apparatus of claim 1, wherein said controller is able to update the access information related to said plurality of files according to access information received from at least one user.

14. The apparatus of claim 13, wherein said secure memory securely stores at least one indicator corresponding to at least one respective set of one or more of said classified files, said indicator indicating one or more authorized users to update access information relating to said set of files; and wherein, based on said indicator, said controller is able to selectively update access information related to a classified file of said set of files with the access information received from said user.

15. The apparatus of claim 1, wherein said requested file comprises a file requested by an administrator, said controller is able to provide said key to said administrator over a secure channel.

16. A method of selectively accessing classified data, the method comprising:
maintaining a plurality of encrypted classified files;
securely maintaining access information related to said classified files and a plurality of keys to decrypt said classified files; and
selectively enabling an encryption module to decrypt a requested file of said classified files using a key of said plurality of keys based on access information related to said requested file.

17. The method of claim 16, wherein the access information related to the requested file includes identification information identifying one or more authorized users to access the requested file, and wherein selectively enabling said encryption module comprises selectively providing said key to said encryption module based on a comparison between said identification information and an identity of a user attempting to access said requested file.

18. The method of claim 17, wherein the access information related to the requested file includes operation information representing one or more authorized operations to be performed by said one or more authorized users, wherein selectively providing said key comprises selectively providing said key to said encryption module based on said operation information.

19. The method of claim 18 comprising enabling said encryption module to encrypt data to be written to said requested file using said key, if said one or more authorized operations include a write operation.

20. The method of claim 17 comprising:
securely maintaining in a session memory an identity value representing said user; and
selectively decrypting said requested file based on a comparison between said identification information and said identity value.

21. The method of claim 20 comprising:
validating said user; and
storing said identity value in said session memory if said user is valid.

22. The method of claim 16 comprising securely maintaining one or more predetermined integrity values related to one or more of said plurality of classified files, respectively.

23. The method of claim 22, wherein the one or more predetermined integrity values include a stored integrity value related to said requested file, the method including:
calculating an integrity value of said requested file; and
ensuring the integrity of said requested file based on a comparison between the calculated integrity value and the stored integrity value related to said file.

24. The method of claim 16 comprising:
securely storing a generated key corresponding to a file to be stored and access information corresponding to the file to be stored; and
enabling said encryption module to encrypt the file to be stored using said generated key.

25. The method of claim 24 comprising securely maintaining an integrity value related to the file to be stored.

26. The method of claim 16 comprising maintaining said plurality of keys and said access information in one or more tables including a plurality of records, at least one of said records including a file identification to identify a file of said classified files, access information corresponding to the identified file, and a key corresponding to the identified file.

27. The method of claim 16 comprising updating the access information related to said plurality of files according to access information received from at least one user.

28. The method of claim 27 comprising:
securely maintaining at least one indicator corresponding to at least one respective set of one or more of said classified files, said indicator indicating one or more authorized users to update access information relating to said set of files; and
based on said indicator, selectively updating access information related to a classified file of said set of files with the access information received from said user.

29. The method of claim 16, wherein said requested file comprises a file requested by an administrator, the method comprising providing said key to said administrator over a secure channel.

30. A system comprising:
a host to manage a file system including a plurality of encrypted classified files; and
a secure control configuration to securely store access information related to said classified files, receive a request from said host to access a requested file of said classified files, and selectively enable said host to access said requested file based on said access information.

31. The system of claim 30, wherein said secure control configuration comprises:
an encryption module;
a secure memory to securely store said access information and a plurality of keys to decrypt said classified; and
a controller to selectively enable said encryption module to decrypt said requested file using a key of said plurality of keys based on access information related to said requested file.

32. The system of claim 31, wherein the access information related to the requested file includes identification information identifying one or more authorized users to access the requested file, and wherein said controller is able to selectively provide said key to said encryption module based on a comparison between said identification information and an identity of a user attempting to access said requested file.

33. The system of claim 31, wherein said secure memory securely stores one or more predetermined integrity values related to one or more of said plurality of classified files, respectively.

34. The system of claim 31, wherein said controller is able to:
securely store in said secure memory a generated key corresponding to a file to be stored in said storage and access information corresponding to the file to be stored; and
enable said encryption module to encrypt the file to be stored using said generated key.

35. The system of claim 31, wherein said plurality of keys and said access information are arranged in one or more tables including a plurality of records, at least one of said records including a file identification to identify a file of said classified files, access information corresponding to the identified file, and a key corresponding to the identified file.
